(19) United States
(12) Patent Application Publication
(10) Pub. No.: US 2026/0007995 A1
(43) Pub. Date: Jan. 8, 2026

(54) IONIC LIQUIDS FOR GAS SORBENTS

(71) Applicants: Avnos, Inc., Los Angeles, CA (US); Georgia Tech Research Corporation, Atlanta, GA (US)

(72) Inventors: Ryan P. Lively, Atlanta, GA (US); João Tiago Vaz Rodrigues Marreiros, Atlanta, GA (US); Benjamin A. McCool, Annandale, NJ (US)

(21) Appl. No.: 19/257,126

(22) Filed: Jul. 1, 2025

Related U.S. Application Data
(60) Provisional application No. 63/667,036, filed on Jul. 2, 2024.

(51) Int. Cl. B01D 53/02

(52) U.S. Cl. CPC B01D 53/02; B01D 2253/20; B01D 2253/311; B01D 2257/504

(57) ABSTRACT

A method of forming an ionic liquid at room temperature combining a first heterocyclic compound having at least one heteroatom in a first heterocycle ring and a second heterocyclic compound having at least one heteroatom in a second heterocycle ring, wherein the first heterocyclic compound acts as a Brønsted acid and the second heterocyclic compound acts as a Brønsted base in an acid-base reaction to form the ionic liquid is disclosed. Furthermore, a carbon dioxide sorbent comprising the ionic liquid and a porous support is claimed. A method of forming the carbon dioxide sorbent comprising incorporating the ionic liquid in pores of a porous support is also disclosed.

### INCORPORATION BY REFERENCE TO ANY PRIORITY APPLICATIONS

Any and all applications for which a priority claim is identified in the Application Data Sheet as filed with the present application are hereby incorporated by reference under 37 CFR 1.57.

### FIELD

The present disclosure relates to the field of ionic liquids and gas sorbents comprising ionic liquids.

### BACKGROUND

Gas sorbents such as carbon dioxide sorbents have been proposed for a number of applications, including as components in carbon dioxide capture processes such as Direct Air Capture (DAC) for removing atmospheric carbon dioxide. In one form of DAC, called Moisture Swing Adsorption (MSA), the sorbent reversibly captures and releases carbon dioxide in response to sorbent humidity levels, a strategy with the potential to decrease energy requirements for carbon dioxide capture from the atmosphere.

### SUMMARY

For purposes of summarizing the invention and the advantages achieved over the prior art, certain objects and advantages of the invention are described herein. Not all such objects or advantages may be achieved in any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

In some aspects, a method of forming an ionic liquid is described. The method includes: combining at room temperature a first heterocyclic compound having at least one heteroatom in a first heterocycle ring and a second heterocyclic compound having at least one heteroatom in a second heterocycle ring, wherein the first heterocyclic compound acts as a Brønsted acid and the second heterocyclic compound acts as a Brønsted base in an acid-base reaction to form the ionic liquid.

In some embodiments, the first heterocyclic compound has at least 2heteroatoms in the first heterocycle ring. In some embodiments, the second heterocyclic compound has at least 2 heteroatoms in the second heterocycle ring.

In some embodiments, the first heterocyclic compound and the second heterocyclic compound are combined in absence of a solvent.

In some embodiments, the first heterocyclic compound, the second heterocyclic compound, or both include a single heterocycle ring.

In some embodiments, the first heterocyclic compound, the second heterocyclic compound, or both include an azole.

In some embodiments, the first heterocyclic compound, the second heterocyclic compound, or both include an imidazole.

In some embodiments, the first heterocyclic compound includes a strongest acidic pKa within 3 units of a strongest basic pKa of the second heterocyclic compound.

In some embodiments, the first heterocyclic compound includes at least one electron-withdrawing group bonded to the first heterocycle ring.

In some embodiments, the at least one electron-withdrawing group includes a halogen atom.

In some embodiments, the second heterocyclic compound includes at least one electron-donating group bonded to the second heterocycle ring.

In some embodiments, the at least one electron-donating group includes a C₁-C₁₀ alkyl group.

In some embodiments, the first heterocyclic compound includes 4,5-dichloroimidazole and the second heterocyclic compound includes 2-ethylimidazole.

In some aspects, a carbon dioxide sorbent is described. The carbon dioxide sorbent includes: an ionic liquid and a porous support, wherein the carbon dioxide sorbent sorbs carbon dioxide upon contact with an air stream including carbon dioxide and releases sorbed carbon dioxide upon contact with moisture or in response to a change in temperature and/or pressure.

In some embodiments, the porous support includes a metal-organic framework material.

In some embodiments, the metal-organic framework material is selected from the group consisting of Fe-MIL-100, MIL-101, MOF-303, MOF-801, MOF-841 and combinations thereof. In some embodiments, the metal-organic framework material is MIL-101(Cr).

In some embodiments, the porous support includes silica.

In some embodiments, the carbon dioxide sorbent releases sorbed carbon dioxide upon contact with moisture.

In some aspects, a method of forming a carbon dioxide sorbent is described. The method includes: a method of forming an ionic liquid and incorporating the ionic liquid in pores of a porous support of the carbon dioxide sorbent.

In some embodiments, the ionic liquid is formed directly within the pores of the porous support of the carbon dioxide sorbent.

In some embodiments, the first heterocyclic compound and the second heterocyclic compound are combined in a liquid carrier, the liquid carrier is introduced into the pores of the porous support, and the liquid carrier is evaporated to form the carbon dioxide sorbent.

In some embodiments, the first heterocyclic compound is combined with a liquid carrier to form a first precursor liquid and the second heterocyclic compound is combined with a liquid carrier to form a second precursor liquid, the first and second precursor liquids are introduced either simultaneously or serially into the pores of the porous support, and the liquid carriers are evaporated to form the ionic liquid in the pores of the porous support.

### BRIEF DESCRIPTION OF THE DRAWINGS

Throughout the drawings, reference numbers can be reused to indicate general correspondence between reference elements. The drawings are provided to illustrate example embodiments described herein and are not intended to limit the scope of the disclosure.

FIG. 1 shows an example Nuclear Magnetic Resonance (NMR) characterization of the resulting ionic liquid revealing presence of proton signals.

FIG. 2 shows an example thermogravimetric analysis revealing thermal stability properties of several ionic liquid infused MOF materials.

FIG. 3 shows an example thermogravimetric analysis related to the nitrogen physisorption isotherms of several ionic liquid infused MOF materials.

FIG. 4 is a schematic illustration of an example custom moisture swing adsorption (MSA) testing platform.

FIG. 5A shows an example analysis based on the custom MSA testing platform for water tracing.

FIG. 5B shows another example analysis based on the custom MSA testing platform for carbon dioxide tracing.

FIG. 6 shows an example MSA result for several MOF materials infused with different amounts of ionic liquid.

### DETAILED DESCRIPTION

The present disclosure can be understood more readily by referencing the following detailed description, examples, drawings, and claims, and their previous and following descriptions. However, before the present apparatuses, sorbents, and methods are disclosed and described, it is to be understood that this disclosure is not limited to the specific apparatuses, sorbents, and methods disclosed unless otherwise specified. It is also to be understood that the terminology used herein is for the purpose of describing particular aspects only and is not necessarily intended to be limiting.

The description is provided as an enabling teaching of the disclosure. To this end, those skilled in the relevant art will recognize and appreciate that many changes can be made to the various aspects of the disclosure described herein while still obtaining beneficial results. It will also be apparent that some of the desired benefits can be obtained by selecting some of the features described herein without utilizing other features. Accordingly, those who work in the art will recognize that many modifications and adaptations to the present description are possible and can even be desirable in certain circumstances and are a part of the present disclosure. Thus, this description is provided as illustrative of certain principles of the present disclosure and not in limitation thereof.

Unless defined otherwise, all technical and scientific terms used herein have the same meaning as is commonly understood by one of ordinary skill practicing in the field of the present disclosure.

### Method of Forming an Ionic Liquid

The present disclosure provides a method for the preparation of ionic liquids by combining at room temperature a Brønsted acid and a Brønsted base. The Brønsted acid-base reaction helps form the ionic liquid.

In some embodiments of the present disclosure, the method includes physically mixing two precursor compounds, one acting as a Brønsted acid and the other acting as a Brønsted base, to spontaneously yield the ionic liquid. In some embodiments, the reaction proceeds without solvents (e.g., absence of a solvent), heating, further workup, or reagent preparation steps. In some embodiments, the ionic liquid is formed at room temperature, for example, between about 20° C. and about 27° C., or about 20° C., about 21° C., about 22° C., about 23° C., about 24° C., about 25° C., about 26°° C. or about 27° C., or any range of values there between.

In some embodiments, a Brønsted acid may be any compound that has a tendency to donate a proton to another compound. In some embodiments, a Brønsted base may be any compound that has a tendency to accept a proton from another compound. In some embodiments, the Brønsted acid and Brønsted base compounds have pKas differing of at least 3 points or 3 points between them, meaning one compound is considerably more acidic than the other compound. In some embodiments, the pKa difference between the compounds acting as Brønsted acid and Brønsted base may be at least 4 points or 4 points.

In some embodiments, the compound acting as a Brønsted base may be a first compound comprising a heterocyclic ring (i.e., a first heterocyclic compound) having at least 1 heteroatom, and the compound acting as a Brønsted acid may be a second compound comprising a heterocyclic ring (i.e., a second heterocyclic compound) having at least 1heteroatom. In some embodiments, the first heterocyclic compound, the second heterocyclic compound, or both, may include a single heterocycle ring. In some embodiments, each of the first compound and the second compound may independently comprise a heterocyclic ring having at least 2 heteroatoms. In some embodiments, each of the first compound and the second compound may independently comprise a heterocyclic ring having 1, 2, 3, or 4 heteroatoms. The heteroatom may be N, S, or O.

In some embodiments, the first compound and the second compound may independently comprise a heterocyclic ring having at least 1 N atom or at least 2 N atoms. In some embodiments, the first compound and the second compound may independently comprise a heterocyclic ring having 1, 2, 3, or 4 N atoms. In some embodiments, the first compound and the second compound may be independently an azole compound.

In some applications, the ionic liquid can be used to form a gas sorbent such as a carbon dioxide sorbent. The ionic liquids disclosed herein are highly hydrophilic and possess good proton conductivity properties while carrying higher density of heteroatom sites due to the inclusion of both positively and negatively charged compounds. The adsorption mechanism of the present disclosure includes the involvement of both positive and negative ions in the adsorption process.

In some embodiments, the heterocyclic ring described herein may be a 5-membered heterocyclic ring. In some embodiments, the heterocyclic ring described herein may be an azole. In some embodiments, the azole may be selected from the group consisting of imidazoles, triazoles, tetrazoles, thiazoles, oxazoles, and pyrazoles. In some embodiments, a number of azole mixtures can be used to form an ionic liquid. In some examples, one of the azole-based compounds intended for ionic liquid synthesis may have acidic characteristics and is a proton donor, while the other has basic characteristics and is a proton acceptor. In some embodiments, the pair of azole compounds have an acid dissociation constant of a solution, pKa, gap larger than 4 or at least 4. In some embodiments, with two or more azole compounds, a first heterocyclic compound may comprise a strongest acidic pKa within 3 units of a strongest basic pKa of the second heterocyclic compound.

In some embodiments, the precursor compounds for forming an ionic liquid further comprise at least one electron-donating group or at least one electron-withdrawing group. Thus, the first and the second heterocyclic compounds may be substituted by one or more substituents that are election-donating or electron-withdrawing. The substituents may include halogen and/or other bulky electron-dense/charged functional groups. In some embodiments, the halogen may be fluorine, chlorine, bromine, and/or iodine. In some embodiments, any one of the heterocyclic compounds may include at least one electron-withdrawing group bonded to one of the heterocycle rings. In some embodiments, the first heterocyclic compound may include at least one electron-withdrawing group bonded to the first heterocycle ring. In some embodiments, the second heterocyclic compound may include at least one electron-donating group bonded to the second heterocycle ring. In some embodiments, the at least one electron-donating group includes a C₁-C₁₀ alkyl group. Examples of azole compounds include, but are not limited to, methylimidazole, ethylimidazole, imidazole, benzimidazole, CF3-imidazole, CHO-imidazole, 4,5-dichloroimidazole, 1,2,3-triazole, 2-Me-5-NO₂-imidazole, 2-NO₂-imidazole, and 5-NO₂-imidazole. In one embodiment, the two precursor compounds that are readily available and low-cost may be 2-ethylimidazole and 4,5-dichloroimidazole. In some embodiment, compounds with more than one ring beside the 5-member ring backbone can be used to form ionic liquids (i.e., benzotriazole and 5-methyl imidazole).

### Method of Forming an Ionic Liquid in Porous Structures

The present disclosure provides an ionic liquid inside the pore confines of a porous structure. In some embodiments, the ionic liquid may be infused into the pores. In some embodiments, the ionic liquid may be formed directly inside (i.e., in situ) the pores. For example, discrete precursor compounds dispersed in a liquid carrier (e.g., methanolic solution) are infused into the pores of a porous structure. The liquid carrier is then evaporated to afford open pore site coordination of said precursor compounds and spontaneous intrapore salt (i.e., an ionic liquid) formation. This synthesizing process allows for an easy tuning of the ionic liquid content by adjusting the concentration of precursor compounds in the infusion solution. This approach also provides the possibility of material re-infusion as well as the assembly of more complex ion species mixtures in porous materials. For example, the use of amine/ammonium infused porous materials with imidazoles allows for better control of amine/ammonium species including loading and helps promote post-infusion formation of MSA active sites.

In situ formation of ionic liquid may proceed as a one-step/one-pot reaction, a sequential reaction, or a vapor-based reaction. In embodiments relating to one-step reaction, the first heterocyclic compound and the second heterocyclic compound are combined in a liquid carrier, the liquid carrier is introduced into the pores of the porous support, and the liquid carrier is evaporated to form the ionic liquid in the pores. In some embodiments, the first heterocyclic compound is combined with a liquid carrier to form a first precursor liquid and the second heterocyclic compound is combined with a liquid carrier to form a second precursor liquid, the first and second precursor liquids are introduced simultaneously or serially into the pores of the porous material, and the liquid carriers are evaporated to form the ionic liquid in the pores of the porous support. In some embodiments, introducing the precursor liquid to the porous material includes adding the porous material into the first precursor liquid, the second precursor liquid, or the mixture of the two precursors liquid.

In embodiments related to sequential reaction, the first precursor liquid is introduced to the pores first, and the carrier liquid of the first precursor liquid is evaporated, then the second precursor liquid is introduced to the pores material, and the carrier liquid of the second precursor liquid is evaporated to result in the formation of the ionic liquid in the porous support. In some embodiments, a heating step may be applied following the evaporation step to further remove any residual carrier liquid.

In embodiments related to vapor-based reaction, the first precursor liquid is introduced to the pores first, and the carrier liquid of the first precursor liquid is evaporated, then optionally dried in an oven overnight. The resulting powder material is placed inside of a sealed container with another small container containing the second precursor liquid also placed inside of the sealed container. The second precursor liquid is then volatilized, allowing the vapor containing the second precursor compound to diffuse into the powder material and react with the first precursor compound to form the ionic liquid in the porous material.

In some embodiments, the porous material/support includes a metal-organic framework material (MOF). In some embodiments, the metal-organic framework material is selected from the group consisting of Fe-MIL-100, MIL-101, MOF-303, MOF-801, MOF-841 and combinations thereof. In some embodiments, the metal-organic framework material is MIL-101 (Cr). In some embodiments, the porous material/support includes silica.

In some applications, the ionic liquid can be used to form a gas sorbent such as a carbon dioxide sorbent. The ionic liquids disclosed herein are highly hydrophilic and possess good proton conductivity properties while carrying higher density of heteroatom sites due to the inclusion of both positively and negatively charged compounds. The adsorption mechanism of the present disclosure includes the involvement of both positive and negative ions in the adsorption process. In some embodiments, the carbon dioxide sorbent sorbs carbon dioxide upon contact with an air stream including carbon dioxide and releases sorbed carbon dioxide upon contact with moisture or in response to a change in temperature and/or pressure. In some embodiments, the carbon dioxide sorbent releases sorbed carbon dioxide upon contact with moisture.

### EXAMPLES

Example embodiments of the present disclosure, including processes, materials and/or resultant products, are described in the following examples.

### Example 1—Formation of an Ionic Liquid

An ionic liquid was formed by mixing two chemical compounds, 2-ethyl imidazole and 4,5-dichloro imidazole in a reaction vessel. As the powders came into contact with each other, the reaction was initiated, i.e. an acid/base proton exchange, resulting in the generation of a salt which is liquid at room temperature, i.e., the ionic liquid.

More specifically, the proton exchange reaction between a first heterocyclic compound and a second heterocyclic compound produced an ionic liquid at room temperature (i.e., 20-25° C.) and was demonstrated by the example below where two imidazoles were mixed together: 2-ethylimidazole as the first heterocyclic compound and 4,5-dichloroimidazole as the second heterocyclic compound.

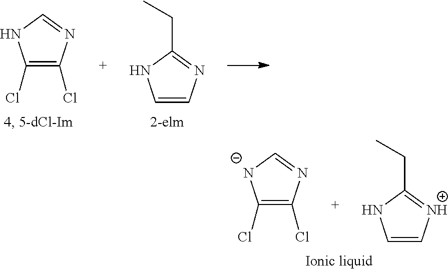

The ionic liquid was spontaneously formed with equimolar amounts of the two compounds in a 1:1 ratio. Mixing the two compounds in this proportion resulted in the formation of a viscous, honey-like thick liquid with a dark red color. Supplementary essays were conducted in which an excess of the more acidic imidazole, 4,5-dichloro imidazole, was added to a fixed amount of 2-ethyl imidazole (basic azole). Mixtures with a 25% and 100% molar excess of 4,5-dichloro imidazole both provided formation of an ionic liquid (e.g., 1.25:1 and 2:1 ratios). In both cases, the proton exchange reaction and ionic liquid formation occurred faster than in the case of equimolar imidazole mixing (1:1 ratio). The resulting ionic liquids formed with excess of the acidic imidazole were more fluid, i.e., less viscous flowing, than the original ionic liquid sample obtained from the equimolar mixing of imidazoles.

### Example 2—Characterization of the Ionic Liquid

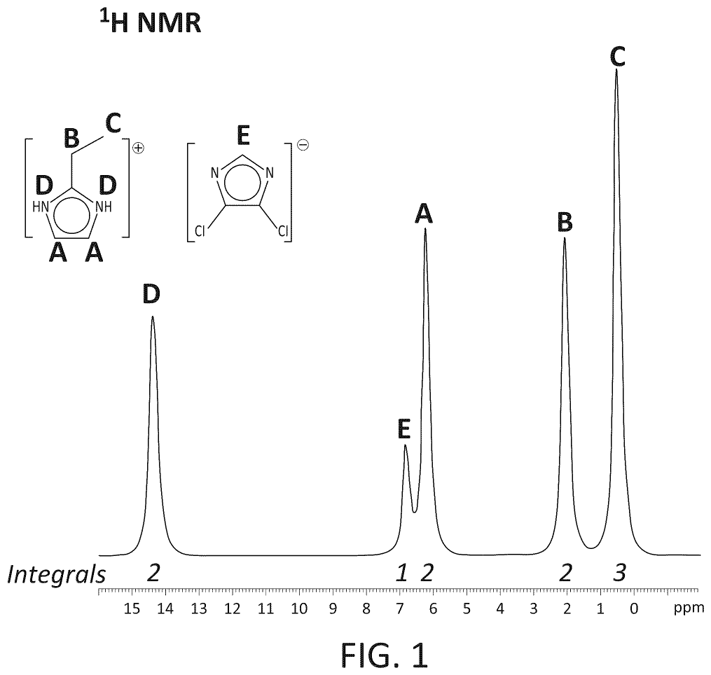

FIG. 1 shows an example Nuclear Magnetic Resonance (NMR) characterization of the resulting ionic liquid revealing presence of proton signals. FIG. 1 depicts NMR characterization of the resulting ionic liquid described in Example 1 revealing the presence of the characteristic proton signals expected for an ionic liquid as described herein. In FIG. 1, the two protons are determined from the peak integration of the signal at about 14 ppm (denoted as “D”) which are attributed to the symmetric protonation of the heteroatoms (e.g., nitrogen atoms) in the 2-ethylimidazole compound.

A-E signals were assigned based on the 1H NMR signals of the pure, unmixed compounds: 2-ethyl imidazole and 4,5-dichloro imidazole. A-D signals correspond to the 1H signals of the protons of the positively charged 2-ethyl imidazole while the E signal corresponds to the only proton left in the negatively charged 4,5-dichloro imidazole. The proposed assignment of NMR signals was corroborated by the peak integration values, shown below on the baseline of FIG. 1. The NMR spectrum showed that no chemical modification of the imidazoles backbone occurred when both compounds were mixed, as the proton resonances matched the predicted spectrum for the respective imidazolium/imidazolate pair.

### Example 3—Methods of Forming a Carbon Dioxide Sorbent Comprising the Ionic Liquid

A carbon dioxide sorbent comprising an ionic liquid was directly formed inside the pore confines of a MOF support (e.g., MIL-101(Cr)), through the infusion of discrete azole compounds (e.g., 2-ethylimidazole and 4,5,-dichloroimidazole), dispersed in a methanolic solution, which was later evaporated to afford open metal site coordination of said azoles and spontaneous intrapore salt formation, i.e., ionic liquid.

The above infusion process included the solution-based infusion of the imidazoles of interest in a methanol solution (i.e., liquid carrier) or solvent (e.g., dimethyl sulfoxide) of known concentration, followed by a controlled evaporation of the solvent, resulting in the in situ generation of ionic liquid within the confines of the material pores. Unlike the formation of an ionic liquid which does not use any solvents, the infusion process includes the use of a liquid carrier and/or solvent. The below example is a schematic illustration of an azolate infusion process using a metal organic framework (MOF), i.e., MIL-101.

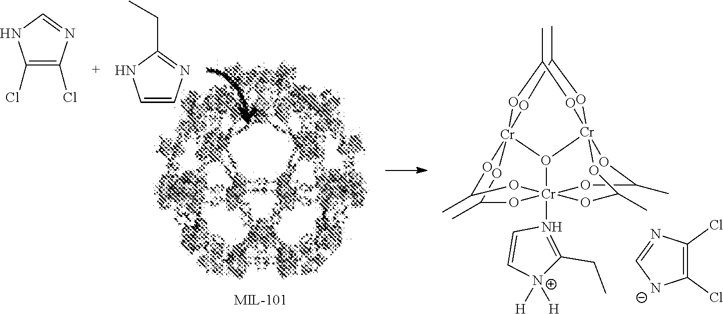

One example of an azolate infusion process included using a one-step in situ infusion process. The one-step in situ infusion process included the simultaneous mixing of the azoles to yield ionic liquid in a MOF. A methanol solution (100 mL) containing the two azole compounds (0.25-3 mmol) of interest (i.e., 2-ethylimidazole and 4,5-dichloroimidazole) was prepared through dissolution of the compounds in the solvent at room temperature (between 20-25° C.). A small amount (about 250 mg) of MOF powder (e.g., MIL-101 (Cr)) was dispersed into the solution and left to stir at room temperature (between 20-25° C.) for 24 hours, followed by solvent evaporation in a rotavap (100-160 mbar vacuum level, 35°° C. bath temperature). The resulting powder material was then dried in an oven at 50° C. overnight (e.g., at least 12 hours).

Another example of an azolate infusion process included the sequential in situ infusion process. The sequential in situ infusion process infused azoles yielded ionic liquid in a MOF. A methanol solution (100 mL) containing one of the azole compounds (0.25-3 mmol) of interest (e.g., 2-ethylimidazole) was prepared through dissolution of the compound in the solvent at room temperature (between 20-25° C.). A small amount (about 250 mg) of MOF powder (e.g., MIL-101(Cr)) was dispersed onto the solution which was left to stir at room temperature (between 20-25° C.) for 24 hours, followed by solvent evaporation in a rotavap (100-160 mbar vacuum level, 35° C. bath temperature). The resulting powder material was then dried in an oven at 50° C. overnight. A second methanol infusion process was undertaken for the second azole compound of interest (e.g., 4,5-dichloroimidazole) in order to allow the in situ generation of ionic liquid. The final material was dried in an oven at 50° C. overnight (e.g., at least 12 hours).

Another example of an azolate infusion process included the sequential in situ infusion process with a vapor phase step. The sequential in situ infusion process with a vapor phase step of azoles yielded an ionic liquid in a MOF. An initial methanol solution (100 mL) containing one of the azole compounds (0.25-3 mmol) of interest (e.g., 2-ethylimidazole) was prepared through dissolution of the compound in the solvent at room temperature (between 20-25° C.). A small amount (about 250 mg) of MOF powder (e.g., MIL-101(Cr)) was dispersed onto the solution which was left to stir at room temperature (between 20-25° C.) for 24 hours, followed by solvent evaporation in a rotavap (100-160 mbar vacuum level, 35° C. bath temperature). The resulting powder material was dried in an oven at 50° C. overnight (e.g., at least 12 hours) and afterwards placed inside a pressure resistant container along with a small vial containing the second azole compound of interest (i.e., 4,5-dichloroimidazole), which was then volatilized. A small open container for the more volatile azole compound was used to ensure that both the MOF and the azole did not physically contact each other. The reactor containing both the azole vial and the MOF powder was sealed and placed in an oven set for 80° C. and left to react for 24 hours. The vapor diffused into the MOF powder, reacting with the already present azole, forming the ionic liquid in situ. The MOF powder was then collected, placed in an oven under vacuum overnight at 50° C. to remove any excess adsorbed and unreacted azole molecules.

### Example 4—Characterization of the Carbon Dioxide Sorbent Comprising the Ionic Liquid

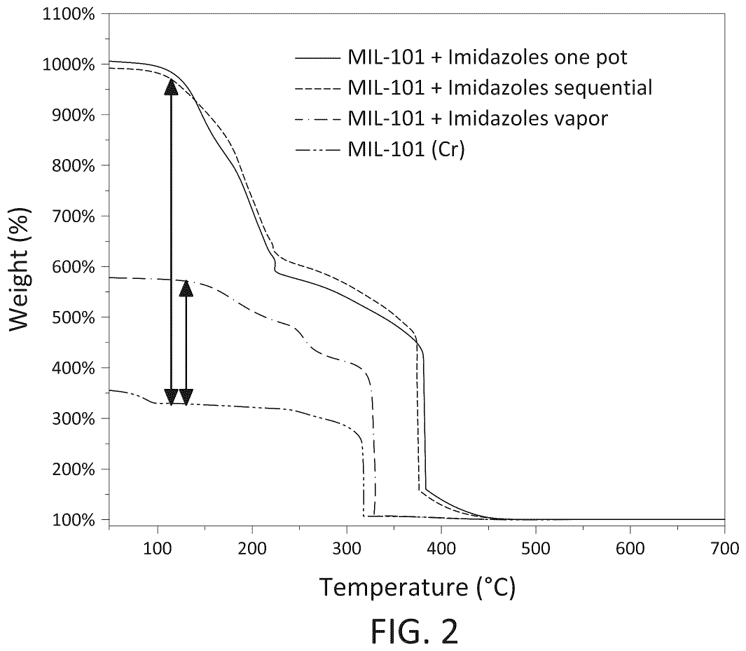

FIG. 2 shows an example thermogravimetric analysis revealing thermal stability properties of several ionic liquid infused MOF materials. Thermogravimetric analysis (TGA) of the activated samples revealed the quantitative loading of the support framework (e.g., MIL-101) with the azole compounds (e.g., imidazoles) at different temperatures using various infusion methods. As shown in FIG. 2, the materials showed high weight loadings of the infused organic compounds, providing evidence of ionic liquids present in the pores of the MOF support.

Table 1 is a summary of FIG. 2, showing the first weight loss step temperature and framework decomposition temperature. As shown in Table 1 below, TGA analysis further revealed good thermal stability of the carbon dioxide sorbent materials below with negligible mass losses below 120° C. for the solution infused samples and 160° C. for the vapor infused material. The characterization of the infusion methods and the infused amount of azolates affected the overall physical-chemical stability of the infused materials.

TABLE 1

| | One Pot/Sequential | | Vapor |
|---|---|---|---|
| 1^{st} Weight Loss Step | 120° | C. | 160° C. |
| Imidazole Loading | ~8 mmol/g (assuming | | ~3.5 mmol/g (assuming |
| | 1:1 ratio) | | 1:1 ratio) |
| Framework | 375-380° | C. | 330° C. |
| Decomposition | | | |

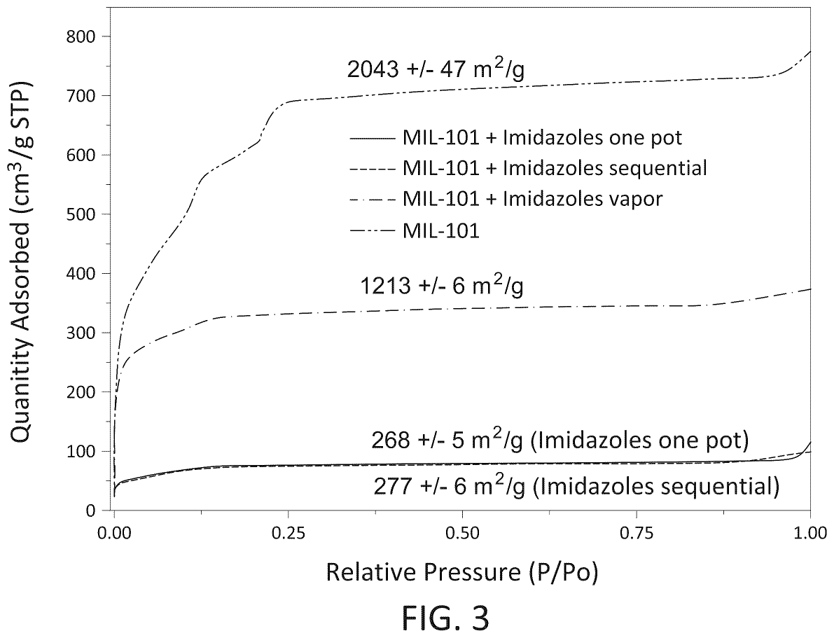

The TGA was also used to show that the ionic liquid occupied the pore volume of the MOF particles. FIG. 3 shows an example thermogravimetric analysis related to the nitrogen physisorption isotherms of several ionic liquid infused MOF materials.

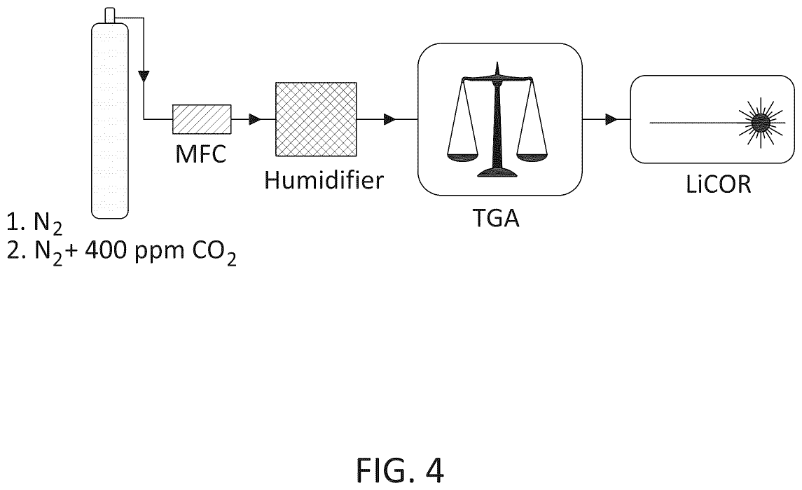

A custom testing platform was used to acquire the performance parameters of a carbon dioxide sorbent comprising an ionic liquid. FIG. 4 is a schematic illustration of an example custom moisture swing adsorption (MSA) testing platform. The carbon dioxide capture performance of a class of hybrid materials (e.g., the ionic liquid infused MOF) was screened with recourse to a humid feed TGA setup. The customized TGA setup allowed for the monitoring of the sorbent material weight when exposed to varying gas feeds. The customized TGA setup comprised pure nitrogen and nitrogen feed with about 400 ppm CO₂, a mass flow controller (MFC), a humidifier, a TGA system, and a system for detecting H₂O (water) and CO₂ (carbon dioxide) content.

The feeds were shifted between pure nitrogen and nitrogen with about 400ppm CO₂ (simulated air), both in dry and humid conditions. The output feed humidity and CO₂concentration were monitored through the use of a dedicator gas analyzer (e.g., LiCOR Li-850), which was capable of detecting solely water and carbon dioxide contents in gas feeds.

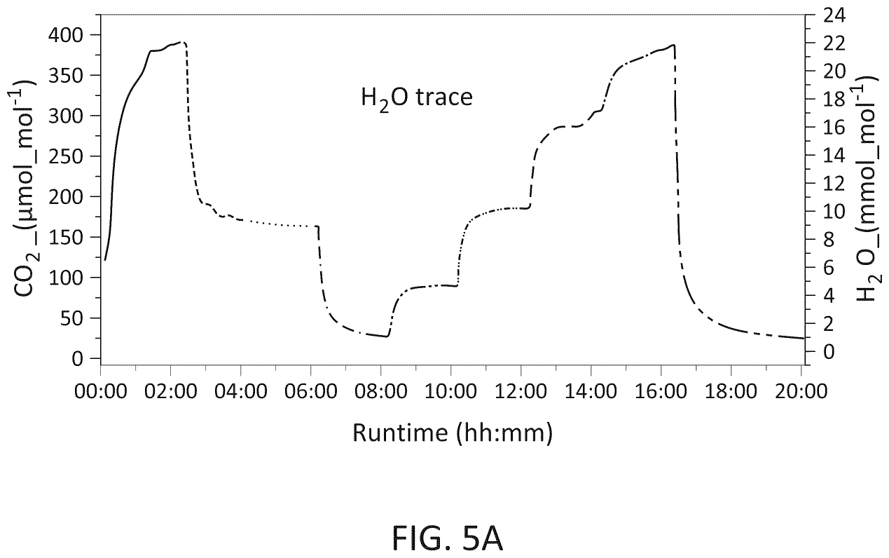

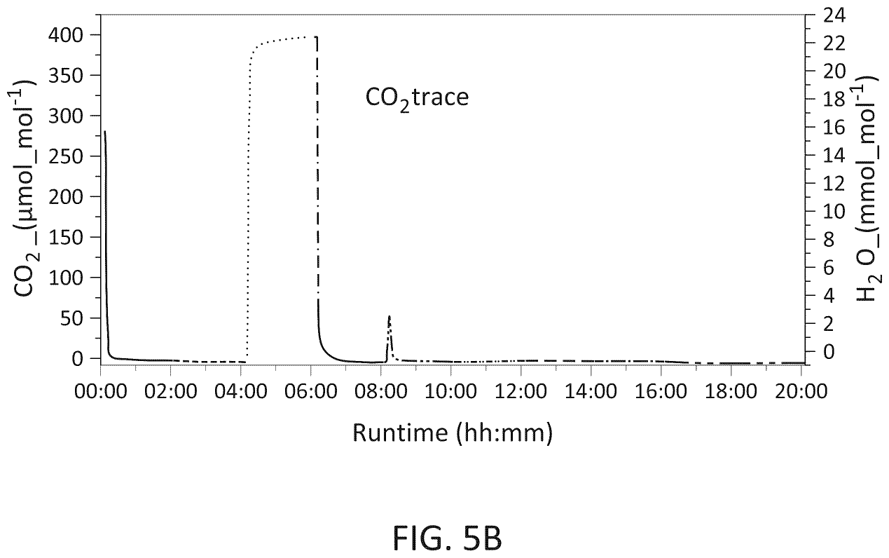

Using the custom testing platform in FIG. 4, the carbon dioxide sorbent comprising the ionic liquid demonstrated high performance adsorption. FIG. 5A shows an example analysis based on the custom MSA testing platform for water tracing. FIG. 5B shows another example analysis based on the custom MSA testing platform for carbon dioxide tracing.

The custom testing program conducted for the in situ activation of the sorbent materials comprised flowing high humidity (40% RH at 35° C.) nitrogen for 2 hours, followed by 2 hours of nitrogen flow with low humidity (15% RH at 35° C.). The sorbent materials were then exposed to 400 ppm CO₂ balanced with nitrogen along with low humidity content (15% RH at 35° C.) for 2 hours before initiating the desorption part of the testing. Furthermore, desorption consisted of 2-hour exposure times to dry nitrogen, followed by 10% RH increments at a constant temperature of 35° C. This approach provided the amount of CO₂ released per amount of water in contact with the sorbent.

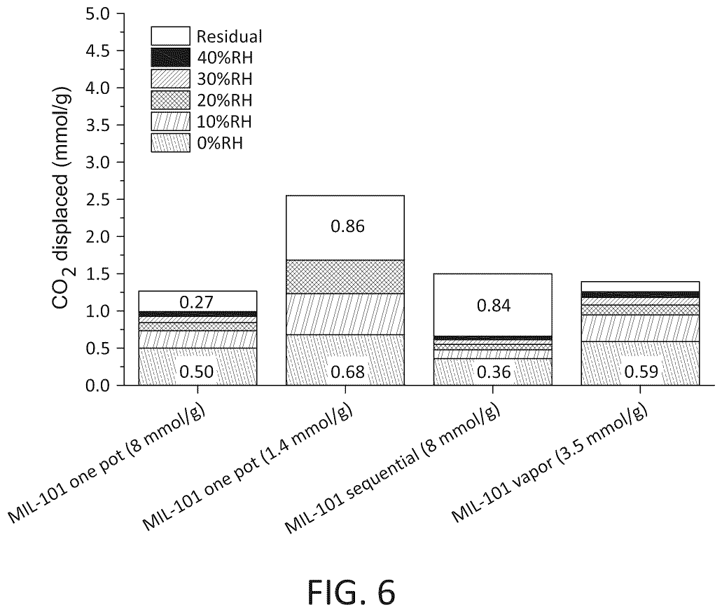

FIG. 6 shows an example MSA result for several MOF materials infused with different amounts of ionic liquid. FIG. 6 depicts the improved performance of the sorbent material samples infused with lower ionic liquid amounts, providing that the specific moisture swing adsorption performance of said materials is correlated to the weight loading of the ionic liquids.

As shown in FIG. 6, the sample containing the lowest loading recorded to date (e.g., MIL-101(Cr)+1.4 mmol IL (one pot)), about 1.4 mmol/g, exhibited high CO₂ adsorption capacity as well as swing capacity when exposed to 20% RH at 35° C. This sample provided improved reactivity and sorption capacity. Moreover, the ratio between adsorbed CO₂ and charged nitrogen sites in the ionic liquid recorded for the 1.4 mmol/g ionic liquid sample provided a distinct stoichiometric ratio from the commonly reported adsorption mechanisms for this class of sorbents. Additionally, the 2.54 mmol/g CO₂ to 1.4 mmol/g ionic liquid provided that both positively and negatively charged imidazoles were active in the moisture swing adsorption process. For example, CO₂ generally adsorbs at ammonium (quaternary ammonium group) MSA sites with a stoichiometry of one molecule of CO₂ for every two ammonium sites (i.e., 1:2 ratio). However, in the present disclosure, the ionic liquid resulting from mixing 2-ethylimidazole and 4,5-dichloroimidazole captured CO₂ with a ratio of two CO₂ molecules per ammonium site (1:1 ratio), thereby significantly improving reactivity and sorption capacity.

What is claimed is:

1. A method of forming an ionic liquid, comprising:
combining at room temperature a first heterocyclic compound having at least one heteroatom in a first heterocycle ring and a second heterocyclic compound having at least one heteroatom in a second heterocycle ring, wherein the first heterocyclic compound acts as a Brønsted acid and the second heterocyclic compound acts as a Brønsted base in an acid-base reaction to form the ionic liquid.

2. The method of claim 1, wherein the first heterocyclic compound has at least 2 heteroatoms in the first heterocycle ring.

3. The method of claim 1, wherein the second heterocyclic compound has at least 2 heteroatoms in the second heterocycle ring.

4. The method of claim 1, comprising combining the first heterocyclic compound and the second heterocyclic compound in absence of a solvent.

5. The method of claim 1, wherein the first heterocyclic compound, the second heterocyclic compound, or both comprise a single heterocycle ring.

6. The method of claim 1, wherein the first heterocyclic compound, the second heterocyclic compound, or both comprise an azole.

7. The method of claim 3, wherein the first heterocyclic compound, the second heterocyclic compound, or both comprise an imidazole.

8. The method of claim 5, wherein the first heterocyclic compound comprises 4,5-dichloroimidazole and the second heterocyclic compound comprises 2-ethylimidazole.

9. The method of claim 1, wherein the first heterocyclic compound comprises a strongest acidic pKa within 3 units of a strongest basic pKa of the second heterocyclic compound.

10. The method of claim 1, wherein the first heterocyclic compound comprises at least one electron-withdrawing group bonded to the first heterocycle ring.

11. The method of claim 10, wherein the at least one electron-withdrawing group comprises a halogen atom.

12. The method of claim 1, wherein the second heterocyclic compound comprises at least one electron-donating group bonded to the second heterocycle ring.

13. The method of claim 12, wherein the at least one electron-donating group comprises a C₁-C₁₀ alkyl group.

14. A carbon dioxide sorbent comprising:
an ionic liquid comprising a first heterocyclic compound having at least one heteroatom in a first heterocycle ring and a second heterocyclic compound having at least one heteroatom in a second heterocycle ring, wherein the first heterocyclic compound acts as a Brønsted acid and the second heterocyclic compound acts as a Brønsted base in an acid-base reaction to form the ionic liquid; and
a porous support, wherein a carbon dioxide sorbent sorbs carbon dioxide upon contact with an air stream comprising carbon dioxide and releases sorbed carbon dioxide upon contact with moisture or in response to a change in temperature and/or pressure.

15. The carbon dioxide sorbent of claim 14, wherein the porous support comprises a metal-organic framework material.

16. The carbon dioxide sorbent of claim 15, wherein the metal-organic framework material is selected from the group consisting of Fe-MIL-100, MIL-101, MOF-303, MOF-801, MOF-841, and combinations thereof.

17. The carbon dioxide sorbent of claim 16, wherein the metal-organic framework material is MIL-101(Cr).

18. The carbon dioxide sorbent of claim 14, wherein the porous support comprises silica.

19. The carbon dioxide sorbent of claim 14, wherein the carbon dioxide sorbent releases sorbed carbon dioxide upon contact with moisture.

20. A method of forming a carbon dioxide sorbent, comprising:
combining at room temperature a first heterocyclic compound having at least one heteroatom in a first heterocycle ring and a second heterocyclic compound having at least one heteroatom in a second heterocycle ring, wherein the first heterocyclic compound acts as a Brønsted acid and the second heterocyclic compound acts as a Brønsted base in an acid-base reaction to form an ionic liquid; and
forming the ionic liquid in pores of a porous support of the carbon dioxide sorbent of claim 14.

21. The method of claim 20, wherein the ionic liquid is formed directly within the pores of the porous support of the carbon dioxide sorbent.

22. The method of claim 20, comprising combining the first heterocyclic compound and the second heterocyclic compound in a liquid carrier, introducing the liquid carrier into the pores of the porous support, and evaporating the liquid carrier to form the carbon dioxide sorbent.

23. The method of claim 20, comprising:
combining the first heterocyclic compound with a liquid carrier to form a first precursor liquid;
combining the second heterocyclic compound with a liquid carrier to form a second precursor liquid;
introducing the first and second precursor liquids, either simultaneously or serially, into the pores of the porous support; and
evaporating the liquid carriers to form the ionic liquid in the pores of the porous support.
